(19) United States
(12) Patent Application Publication
(10) Pub. No.: US 2008/0049035 A1
(43) Pub. Date: Feb. 28, 2008

(54) Apparatus and method for accessing image data

(75) Inventor: Shingo Kuroda, Yokohama (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/654,499

(22) Filed: Jan. 18, 2007

(30) Foreign Application Priority Data
Aug. 25, 2006 (JP) 2006-228535

(51) Int. Cl. G06F 13/00

(52) U.S. Cl. 345/536

(57) ABSTRACT

Apparatus and method for accessing image data in reduced transfer cycles. The image data access apparatus has: a plurality of external memories in which a plurality of parallel pixel data that are adjacent to each other in a prescribed block area of the image data are separately stored at assigned addresses; a determination circuit for outputting, based on the coordinate of at least one pixel data out of a plurality of parallel data, a memory selection signal for selecting an access route to an external memory storing the one pixel data, the coordinate obtained by raster scanning; and a memory selector for selecting access routes to the plurality of external memories based on the received memory selection signal, and accessing the plurality of parallel pixel data in the same cycle. This can realize accessing the pixel data in the external memories in reduced transfer cycles.

### CROSS-REFERENCE TO RELATED APPLICATIONS

This application is based upon and claims the benefits of priority from the prior Japanese Patent Application No. 2006-228535, filed on Aug. 25, 2006, the entire contents of which are incorporated herein by reference.

### BACKGROUND OF THE INVENTION

(1) Field of the Invention

This invention relates to an apparatus and method for accessing image data, and more particularly to an apparatus and method for accessing image data with a technique of controlling access to a plurality of external memories.

(2) Description of the Related Art

In a moving picture compression technique for performing motion estimation, such as Moving Picture Experts Group (MPEG), motion compensation is performed in a decoding process by using previously decoded images as reference images. In order to enhance accuracy of the motion compensation, not a single reference image but a plurality of reference images may be required. For this reason, a large-capacity external memory is provided in a decoder device (for example, refer to Japanese Unexamined Patent Publications No. 10-304354 and No. 2004-215049).

In addition, in order to enhance accuracy of the motion compensation, filtering is performed macroblock by macroblock or submacroblock by submacroblock. Especially, under the H. 264 standards, a 6-tap filter is required for reference images to be used in the motion compensation, and therefore one frame is partitioned into a large number of blocks.

In a case of taking 8×8 blocks as a macroblock, one macroblock comprises 64 blocks, including luminance and color difference data. Out of the blocks, rectangular pixel blocks (hereinafter, referred to as rectangular data) to be filtered are sequentially extracted from an external memory.

FIG. 7 shows rectangular data of various sizes in 8×8 blocks. Illustrated rectangular data are a 5×3 block A area, a 1×4 block B area, and a 4×1 block C area. A symbol s(X, Y) (X: 0 to 7, Y: 0 to 7) is pixel data of coordinate (X, Y) in the 8×8 blocks.

In order to perform motion compensation, rectangular data of different sizes are successively extracted from an external memory and are filtered. In addition, to filter large-volume rectangular data at a high speed, a plurality of pixel data of the rectangular data in the external memory are accessed in parallel.

A principle of making parallel access to a plurality of pixel data in an external memory will be described. FIG. 8 shows assignment of addresses in the external memory to pixel data. As shown in FIG. 8, two pieces of adjacent pixel data are assigned in parallel one address in the external memory. For example, two pieces of pixel data, s(0, 0) and s(1, 0), are stored at address “0” in the external memory, so that these two pixel data are accessed in parallel, resulting in realizing faster access and reducing the number of transfer cycles.

However, if rectangular data comprises an odd number of pixel data in a horizontal direction as shown in FIG. 7, that is, if two pieces of pixel data assigned the same address comprises pixel data of the rectangular data and pixel data that is outside the rectangular data, the outside pixel data is unnecessarily extracted in a transfer cycle. A reason for this will be now described.

FIGS. 9A to 9C show transfer cycles for accessing rectangular data in an external memory. FIG. 9A shows transfer cycles for accessing the pixel data of the block A area of FIG. 7 in the external memory. To access all pixel data of the block A area in the external memory, nine cycles are required as shown in FIG. 9A. Since two pieces of pixel data assigned the same address in the same external memory are accessed in parallel, s(0,1), s(0, 2), s(0, 3) in FIG. 9A which are pixel data outside the block A area are also accessed. That is to say, such unnecessary pixel data increases the number of transfer cycles.

Further, FIG. 9B shows transfer cycles for accessing the pixel data of the block B area of FIG. 7 in the external memory. To access all pixel data of the block B area in the external memory, four transfer cycles are required. Since two pieces of pixel data assigned the same address in the same external memory are accessed in parallel, s(7, 4), s(7, 5), s(7, 6), and s(7, 7) in FIG. 9B which are pixel data outside the block B area are also accessed. That is to say, such unnecessary pixel data increases the number of transfer cycles.

Furthermore, FIG. 9C shows transfer cycles for accessing pixel data of the block C area of FIG. 7 in the external memory. To access all pixel data of the block C area in the external memory, three transfer cycles are required. Since two pieces of pixel data assigned the same address in the same external memory are accessed in parallel, s(0, 6) and s(5, 6) in FIG. 9C which are pixel data outside the block C area are also accessed. That is to say, such unnecessary pixel data increases the number of the transfer cycles.

As a result, assignment of the same address in an external memory to adjacent data produces a drawback in that, if rectangular data has an odd number of pixel data in a horizontal direction, unnecessary pixel data in the external memory is wastefully accessed, resulting in requiring more transfer cycles and so being incapable of transferring pixel data in the external memory at a faster transfer rate.

### SUMMARY OF THE INVENTION

This invention has been made in view of foregoing and intends to an apparatus and method for accessing image data in reduced transfer cycles that are used for accessing pixel data in external memories.

To accomplish the above object, there is provided an apparatus for accessing image data in external memories. This image data access apparatus comprises: a plurality of external memories in which a plurality of parallel pixel data are separately stored at assigned addresses, the plurality of parallel pixel data being adjacent to each other in a prescribed pixel block area in a prescribed block unit of the image data; a determination circuit for outputting, based on a coordinate of at least one pixel data out of the plurality of parallel pixel data, a memory selection signal for selecting an access route to one of the plurality of external memories corresponding to the one pixel data, the coordinate obtained by raster scanning; and a memory selector for, when receiving the memory selection signal, selecting access routes to the plurality of external memories and accessing the plurality of parallel pixel data in the same cycle.

Further, to accomplish the above object, there is provided a method for accessing image data in external memories. This image data access method comprises the steps of: separately storing a plurality of parallel pixel data at assigned addresses in a plurality of external memories, the plurality of parallel pixel data being adjacent to each other in a prescribed pixel block area in a prescribed block unit of the image data; obtaining coordinates of the plurality of parallel pixel data by raster scanning; selecting access routes to the plurality of external memories corresponding to the plurality of parallel pixel data based on an obtained coordinate of at least one pixel data out of the plurality of parallel pixel data; and accessing the plurality of parallel pixel data in the plurality of external memories in the same cycle.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram showing a principle of accessing image data.

FIG. 2 is a block diagram showing main components of an image data access apparatus.

FIG. 3 shows rectangular data in an 8×8 block unit.

FIGS. 4A and 4B show assignment of addresses in SRAM#A and SRAM#B to pixel data.

FIG. 5 is a flowchart of accessing image data.

FIGS. 6A to 6C show transfer cycles for accessing rectangular data in external memories.

FIG. 7 shows rectangular data in an 8×8 block unit.

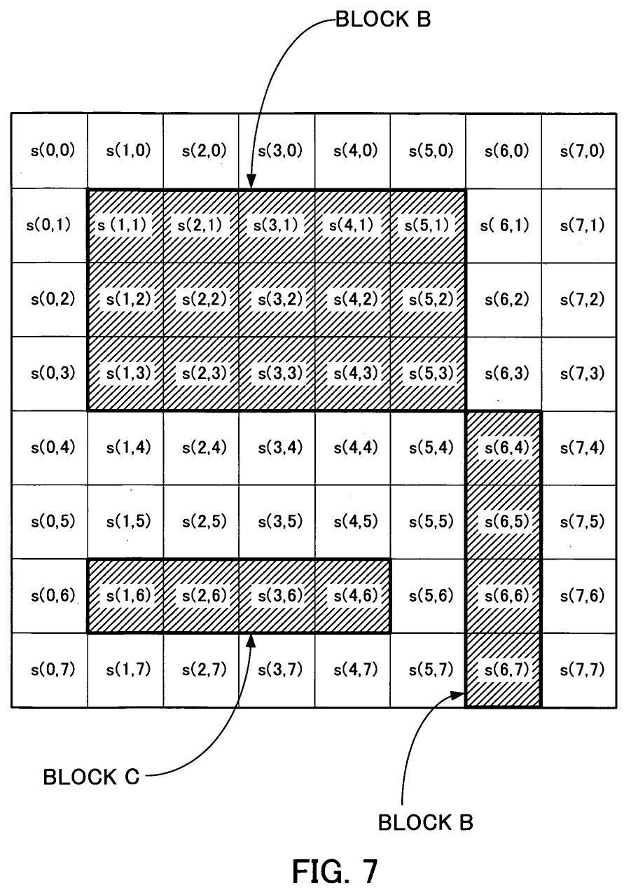

FIG. 8 shows assignment of addresses in an external memory to pixel data.

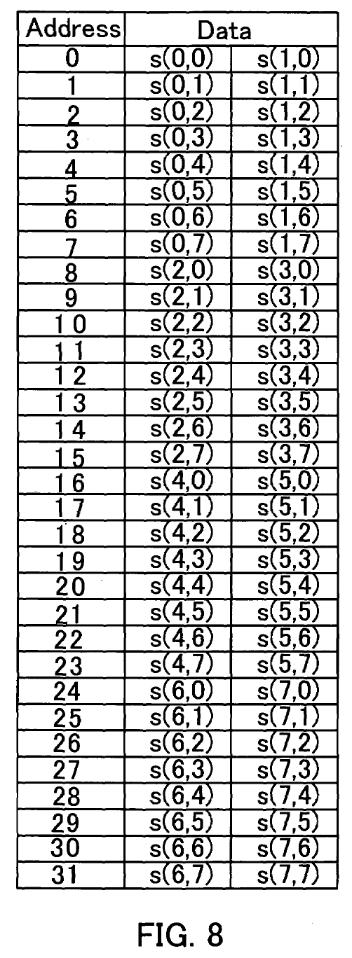

FIGS. 9A to 9C show transfer cycles for accessing rectangular data in an external memory.

### DESCRIPTION OF THE PREFERRED EMBODIMENTS

Preferred embodiments of this invention will be described with reference to the accompanying drawings, wherein like reference numerals refer to like elements throughout.

An outline of accessing image data will be described first.

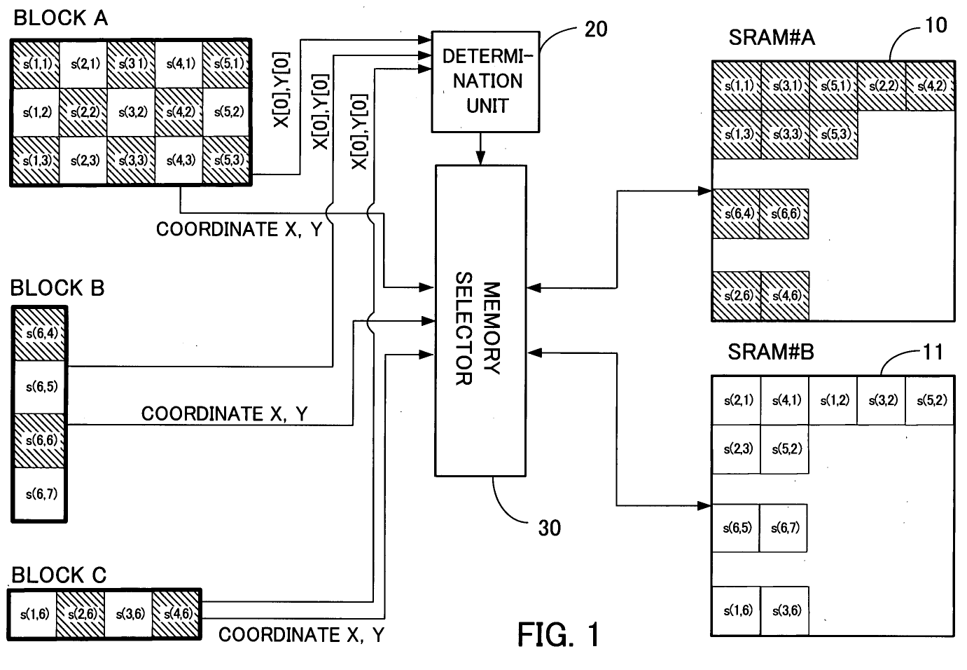

FIG. 1 is a block diagram showing a principle of an image data access apparatus which is designed to access a plurality of adjacent pixel data in parallel in external memories in the same cycle. In this description, pixel data to be accessed in parallel are referred to as parallel pixel data. Referring to FIG. 1, the image data access apparatus has a plurality of external memories, a determination circuit, and a memory selector. In addition, shown as example rectangular data of various sizes are a 5×3 block A area, a 1×4 block B area, and a 4×1 block C area.

The plurality of external memories are Static Random Access Memory (SRAM) #A10 and SRAM#B11, for example.

In the SRAM#A 10 and SRAM#B 11, a plurality of parallel pixel data that are adjacent to each other in a prescribed pixel block area in a prescribed block unit of the image data are separately stored. In addition, the SRAM#A 10 and the SRAM#B 11 are each provided with a function of writing the pixel data of rectangular data at prescribed addresses.

By issuing an access request to the SRAM#A 10 and SRAM#B 11, the memory selector 30 extracts a plurality of parallel adjacent pixel data in the same cycle.

When the coordinates of the pixel data of the block A area, the block B area, or the block C area are obtained by raster scanning, the determination circuit 20 outputs, based on the obtained coordinate of at least one pixel data out of a plurality of parallel pixel data, to the memory selector 30 a signal (hereinafter, referred to as memory selection signal) for selecting an access route to an external memory storing the pixel data.

For example, when the coordinates X, Y of the pixel data of rectangular data are obtained by the raster scanning, the lowest bit information (X[0], Y[0]) of the coordinate of at least one pixel data out of a plurality of parallel pixel data is inputted to the determination circuit 20 which then outputs a memory selection signal corresponding to the pixel data to the memory selector 30.

When receiving the memory selection signal from the determination circuit 20, the memory selector 30 selects access routes to the plurality of external memories, and accesses the plurality of parallel pixel data in the same cycle. Then motion compensation of the image data is performed based on the extracted pixel data.

According to such a technique of accessing image data, a plurality of parallel pixel data in a plurality of external memories can be accessed in the same cycle, without wasteful access to unnecessary pixel data. As a result, the number of transfer cycles for accessing pixel data in a plurality of external memories can be reduced, thus realizing a faster transfer rate.

Next, the configuration of the apparatus which accesses image data will be described in detail.

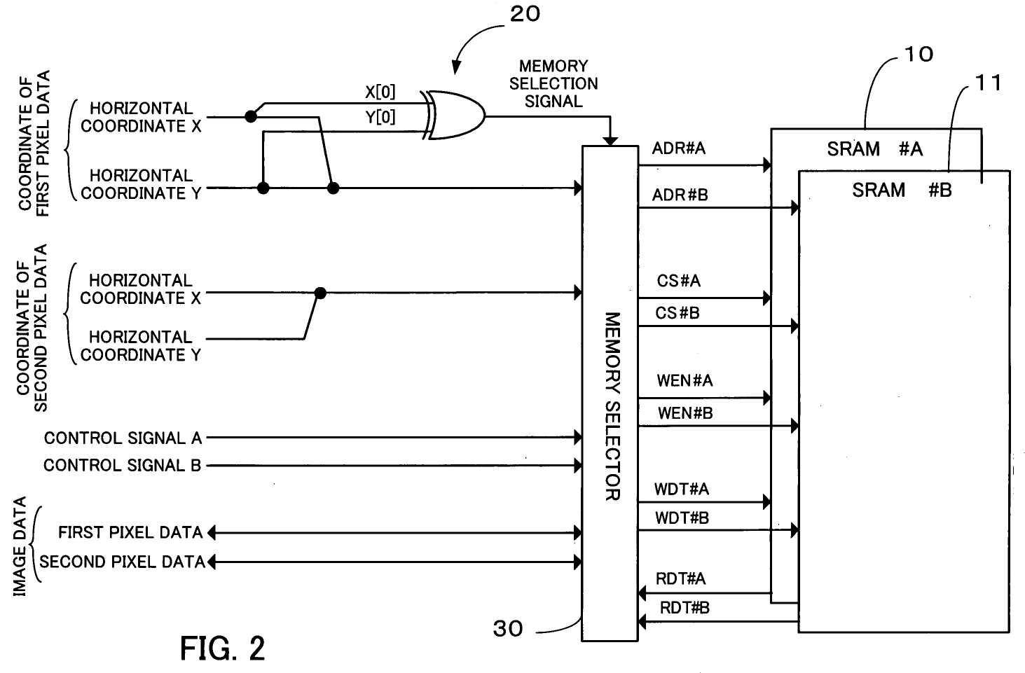

FIG. 2 is a block diagram of the main components of the image data access apparatus. The image data access apparatus has an SRAM#A 10, an SRAM#B 11, a determination circuit 20, and a memory selector 30.

In the SRAM#A 10 and SRAM#B 11, a plurality of parallel data that are adjacent to each other in a prescribed block area in a prescribed block unit of image data are separately stored. In addition, the SRAM#A 10 and SRAM#B 11 are each provided with a function of writing the pixel data of rectangular data at prescribed addresses.

By sending a signal (ADR#A, ADR#B) for specifying an address and a control signal (CS#A, CS#B) to each of the SRAM#A 10 and the SRAM#B 11, the memory selector 30 accesses and extracts a plurality of parallel adjacent pixel data (RDT#A, RDT#B) in the same cycle. In this connection, the control signal (CS#A, CS#B) is a signal indicating that access to a corresponding memory is valid.

Next explanation is about how to assign addresses in the SRAM#A 10 and SRAM#B 11 to the pixel data of rectangular data to store the data.

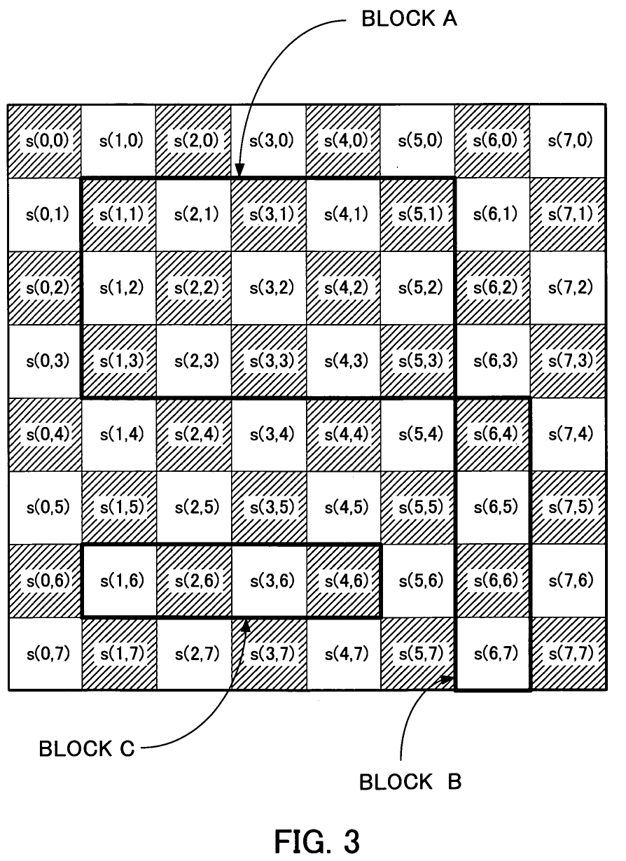

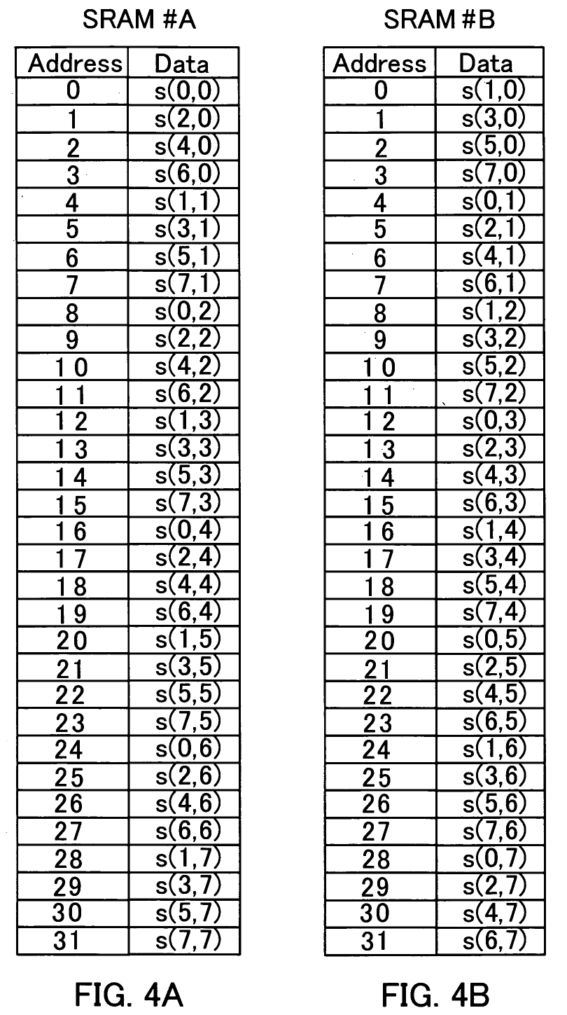

FIG. 3 shows rectangular data in an 8×8 block unit. FIGS. 4A and 4B show which addresses in the SRAM#A 10 and SRAM#B 11 are assigned to pixel data.

As shown in FIGS. 3, 4A and 4B, on a block unit basis, the image data is divided into two in a checker pattern, and pixel data vertically or horizontally adjacent to each other are separately stored in the SRAM#A 10 and SRAM#B 11. That is, hatched pixel data of FIG. 3 are assigned addresses of the SRAM#A 10 while the other pixel data are assigned addresses of the SRAM#B 11. This address assignment allows parallel access to a plurality of adjacent pixel data in a plurality of external memories in the same cycle (will be described later).

The determination circuit 20 of FIG. 2, when receiving the lowest bit information (X[0], Y[0]) of the coordinate X, Y of pixel data of rectangular data, outputs a memory selection signal to the memory selector 30. The determination circuit 20 is an EOR gate circuit, for example, and is designed to perform an Exclusive-OR operation of the lowest bits of the coordinate X, Y, and outputs to the memory selector 30 a memory selection signal for selecting an access route to the SRAM#A 10 or SRAM#B 11 based on its result.

When receiving the coordinate X, Y of the pixel data of the rectangular data, the control signal (CS#A, CS#B), and the memory selection signal from the determination circuit 20, the memory selector 30 outputs a signal (ADR#A, ADR#B) for specifying an address in the SRAM#A 10 or SRAM#B 11, and the control signal (CS#A, CS#B) to each of the SRAM#A 10 and SRAM#B 11, extracts the pixel data (RDT#A, RDT#B) from the SRAM#A 10 and SRAM#B 11.

As described above, the memory selector 30 is capable of selecting external memories corresponding to pixel data of prescribed rectangular data shown in FIG. 3 on the basis of a memory selection signal received from the determination circuit 20, and specifying addresses. Then based on the extracted pixel data, the motion compensation of the image data is performed.

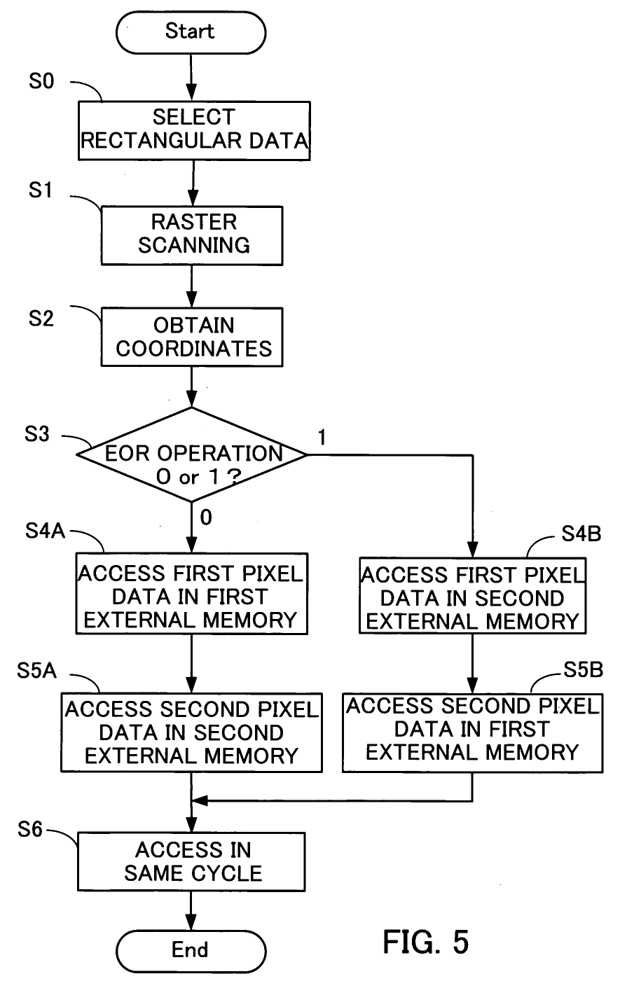

A procedure of accessing image data will be now described with reference to the flowchart of FIG. 5. This explanation will be made in a case where two external memories are prepared and two pieces of pixel data are applied as parallel pixel data.

A rectangular pixel block (rectangular data) of a prescribed size is selected from prescribed blocks of image data required for motion compensation (step S0). Raster scanning is performed on the pixel data of the selected rectangular data in order to scan the coordinates (step S1). With respect to first and second parallel pixel data that are adjacent to each other in the rectangular data, their coordinates (horizontal coordinate (X) and vertical coordinate (Y)) are obtained by the raster scanning (step S2). The coordinates X, Y are inputted to the determination circuit 20 and the memory selector 30. Then, The determination circuit 20 converts both the horizontal coordinate (X) and vertical coordinate (Y) of the first pixel data, for example, out of the parallel pixel data into binary number and performs the Exclusive-OR operation of their lowest bits (step S3).

Based on the result of the Exclusive-OR operation, the memory selector 30 selects an access route to one of the external memories, depending on whether the lowest bits of the horizontal coordinate and the vertical coordinate are identical or different, that is, parity.

If the Exclusive-OR operation results in “0”, for example, then an access route to the first external memory is selected for the first pixel data (step S4A). If the Exclusive-OR operation results in “1”, then an access route to the second external memory is selected for the first pixel data (step S4B).

Then, for the second pixel data, an access route to an external memory different from that for the first pixel data is selected. If the access route to the first external memory is selected for the first pixel data, the access route to the second external memory is selected for the second pixel data (step S5A). If the access route to the second external memory is selected for the first pixel data, the access route to the first external memory is selected for the second pixel data (step S5B).

Then the first and second pixel data in the first and second external memories are accessed in the same cycle. That is, the first and second pixel data in the SRAM#A 10 serving as the first external memory and the SRAM#B 11 serving as the second external memory are accessed in the same cycle (step S6). Then based on the extracted pixel data, the motion compensation of the image data is performed.

According to this procedure, specified addresses in different external memories are accessed in the same cycle for extracting parallel pixel data, which are adjacent to each other in a block unit. That is to say, in the same cycle, a plurality of parallel pixel data in the plurality of external memories can be accessed, without wasteful access to unnecessary pixel data. As a result, the number of transfer cycles required for accessing pixel data in the plurality of external memories can be reduced, thereby realizing a faster transfer rate.

Next, a specific procedure of accessing image data will be specifically described with reference to the flowchart of FIG. 5. A procedure of accessing two pieces of parallel pixel data in two SRAMs will be described by way of example.

First a rectangular pixel block (rectangular data) of a prescribed size is selected from a prescribed block unit of image data required for motion compensation (step S0). It is assumed that a 5×3 block A area, a 1×4 block B area, and a 4×1 bock C area are selected from the 8×8 block unit as shown in FIG. 3. In this connection, a symbol s(X, Y) (X: 0 to 7, Y: 0 to 7) in each block is pixel data of a coordinate (X, Y) in the 8×8 blocks. Each pixel data is stored at an address in either one of the SRAM#A 10 and SRAM#B 11.

A procedure of controlling access to the pixel data of the bock A area in the external memories will be first described.

To scan the coordinates of the pixel data of the block A area, raster scanning is performed on the block A area, starting with s(1, 1) (step S1).

Then, with respect to parallel pixel data of adjacent coordinates, for example, the first pixel data s(1,1) and the second pixel data s(2, 1) that is adjacent thereto, the horizontal and vertical coordinates (X, Y) corresponding to s(1, 1) and s(2, 1) are inputted to the memory selector 30.

Then, the lowest bit information (X[0], Y[0]) of the horizontal and vertical coordinates (binary number) of s(1, 1) is inputted to the determination circuit 20, and the result of Exclusive-OR operation of them is inputted to the memory selector 30 (step S3).

That is, since the pixel data s(1, 1) means a horizontal coordinate of “1” and a vertical coordinate of “1”, the Exclusive-OR operation results in “0”. In this case, an access route to the SRAM#A 10 serving as the first external memory is selected for the pixel data s(1, 1) (step S4A).

With respect to s(2, 1), the memory selector 30 confirms from its horizontal and vertical coordinates (X, Y) that this pixel data is adjacent to s(1, 1), and selects an access route to an external memory different from that for s(1, 1), i.e., the SRAM#B 11 serving as the second external memory (step S5A).

After the access routes are determined for the two pixel data, access to s(1, 1) in the SRAM#A 10 and access to s(2, 1) in the SRAM#B 11 are made in the same cycle.

In the same manner, with respect to the pixel data other than s(1, 1) and s(2, 1) of the block A area, and further the pixel data of the block B area, parallel access is made on a two-pieces-of-adjacent-pixel-data basis.

Now, a procedure of controlling access to the pixel data of the block C area in the external memories will be described.

To scan the coordinates of the pixel data of the block C area, raster scanning is performed on the block C area, starting with s(1, 6) (step S1).

Then, with respect to parallel pixel data of adjacent coordinates, for example, s(1, 6) and s(2, 6) that is adjacent thereto, their horizontal and vertical coordinates (X, Y) are inputted to the memory selector 30.

Then, the lowest bit information (X[0], Y[0]) of the horizontal and vertical coordinates (binary number) of s(1, 6) is inputted to the determination circuit 20, and the result of Exclusive-OR operation of them is inputted to the memory selector 30 (step S3).

That is, in a case of pixel data s(1, 6), the horizontal coordinate is “1” and the vertical coordinate is “110”, so that the Exclusive-OR operation results in “1”. In this case, an access route to the SRAM#B 11 is selected for the pixel data s(1, 6) (step S4B).

With respect to s(2, 6), it is confirmed from the horizontal and vertical coordinates (X, Y) that s(2, 6) is adjacent to s(1, 6). Therefore, an access route to an external memory different from that for s(1, 6), i.e., the SRAM#A 10 is selected (step S5B).

Then, access to s(2, 6) in the SRAM#A 10 and access to s(1, 6) in the SRAM#B 11 are made in the same cycle. With respect to the pixel data of the block C area other than s(1, 6) and s(2, 6), parallel access is made in the same manner on a two-pieces-of-adjacent-pixel-data basis.

In this way, as to two pieces of parallel pixel data that are adjacent in rectangular data, accesses to the pixel data existing at assigned addresses in external memories are made in the same cycle.

The following describes an effect of reducing time to be taken to access pixel data in external memories, by comparing transfer cycles in transferring rectangular data in external memories.

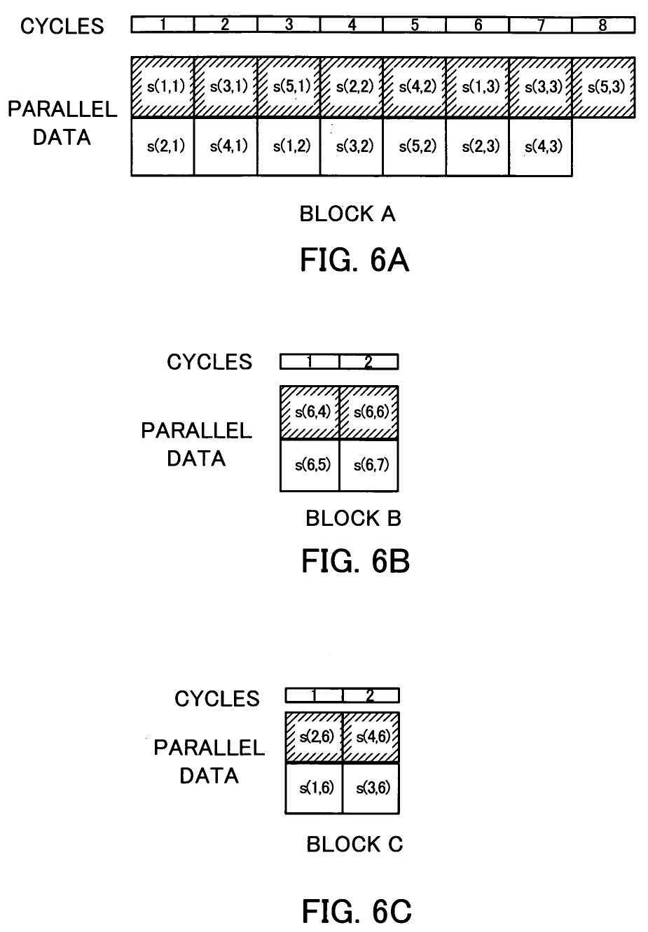

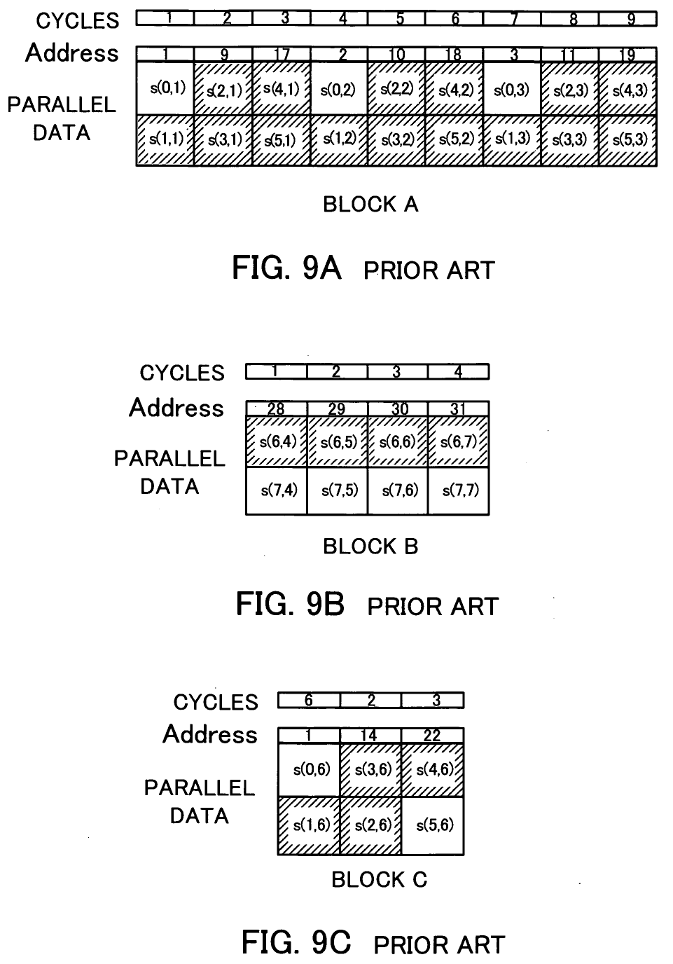

FIGS. 6A to 6C show transfer cycles for rectangular data in external memories. FIG. 6A shows transfer cycles for the rectangular data of the block A area. For accessing the SRAM#A 10 and the SRAM#B 11 in parallel for all pixel data of the block A area, eight transfer cycles are sufficient as shown in FIG. 6A. In FIG. 9A, on the other hand, accesses are made to the external memory for pixel data s(0, 1), s(0, 2), and s(0, 3) that are outside the block A area. In the transfer cycles of FIG. 6A, no access is made for such unnecessary pixel data. The number of transfer cycles of FIG. 6A is one less than that of FIG. 9A.

Further, FIG. 6B shows transfer cycles for the rectangular data of the block B area.

For accessing the external memories in parallel for all pixel data of the block B area, two transfer cycles are sufficient as shown in FIG. 6B. In FIG. 9B, on the other hand, accesses are made to the external memory for pixel data s(7, 4), s(7, 5), s(7, 6), and s(7,7) that are outside the block B area. In the transfer cycles of FIG. 6B, no access is made for such unnecessary pixel data. The number of transfer cycles of FIG. 6B is two less than that of FIG. 9B.

Furthermore, FIG. 6C shows transfer cycles of the rectangular data of the block C area.

For accessing the external memories in parallel for all pixel data of the block C area, two transfer cycles are sufficient as shown in FIG. 6C. In FIG. 9C, on the other hand, accesses are made to the external memory for pixel data s(0, 6) and s(5, 6) that are outside the block C area. In the transfer cycles of FIG. 6C, no access is made for such unnecessary pixel data. The number of transfer cycles of FIG. 6C is one less than that of FIG. 9C.

As a result, the present invention has an advantage in that access to external memories can be made for various rectangular data in reduced transfer cycles, as compared with the conventional access method.

According to this invention, the number of transfer cycles derived from ((POSX+SIZEX+1)>>1−POSX>>1)*SIZEY−(SIZEX*SZEY+1)>>1 can be reduced from the conventional number of transfer cycles shown in FIGS. 9A to 9C. In this formula, “>>” represents a right shift operator, “−”, “+”, and “*” represent subtraction, addition, and multiplication, respectively. “POSX” represents horizontal coordinate of rectangular data, and “SIZEX” and “SIZEY” represent the horizontal and vertical sizes of the rectangular data, respectively.

For example, with respect to the block A area of FIG. 3, it is assumed that the pixel data is extracted starting with s(1, 1). In this case, POSX=1, SIZEX=101 (binary number), and SIZEY=11 (binary number), and therefore, the above formula results in “1”. That is to say, one transfer cycle can be reduced from the conventional transfer cycles (nine cycles) of FIG. 9A.

Further, in a case of filtering a luminance reference image of 13×13 size on an 8×8 macroblock unit basis under H. 264, thirteen processing cycles can be reduced at maximum for every block.

If thirteen cycles can be reduced at maximum for an 8×8 macroblock unit, 848640 cycles could be reduced for a 1920×1088 picture in the bidirectional prediction in which past and future reference images are filtered.

When accesses are successively made to external memories for rectangular data, this embodiment can reduce traffic caused by accessing the external memories and thus make a processing speed faster.

A method of accessing pixel data previously stored in the SRAM#A 10 and SRAM#B 11 has been described so far. With respect to writing pixel data in the SRAM#A 10 and the SRAM#B 11, the pixel data of a prescribed block area of image data is divided into two in a checker pattern, and vertically or horizontally adjacent pixel data can be separately written in the different external memories.

Specifically, when the image data is externally inputted to the memory selector 30, the coordinates of parallel pixel data that are adjacent to each other in a prescribed pixel block area in a prescribed block unit of the image data are inputted to the memory selector 30 and the determination circuit 20.

Then the determination circuit 20 selects external memories corresponding to the parallel pixel data, inputs write signals (WEN#A, WEN#B) to the SRAM#A 10 and SRAM#B 11, and thus the parallel pixel data (WDT#A, WDT#B) are written at assigned addresses in the corresponding SRAM#A 10 and SRAM#B 11.

Further, two SRAMs are used as a plurality of external memories and two pieces of adjacent pixel data are used as parallel pixel data in the above explanation. Alternatively, two or more external memories can be used and memories other than SRAMs can be used. In addition, the number of parallel adjacent pixel data is not limited to two. Two or more pieces of adjacent data can be taken as parallel data and determination circuits and external memories as many as the number of parallel data are prepared, thereby further reducing the number of transfer cycles.

The present invention is directed to accessing image data in external memories. A plurality of parallel pixel data that are adjacent to each other in a prescribed pixel block area in a prescribed block unit of the image data are separately stored at assigned addresses in different external memories, and raster scanning is performed to obtain the coordinates of the plurality of parallel pixel data, an access route to an external memory storing each pixel data is selected based on the coordinate of at least one pixel data out of the plurality of parallel pixel data, and then accesses are made to the plurality of parallel pixel data in the plurality of external memories in the same cycle.

As a result, the image data access can be realized in reduced transfer cycles that are used for accessing the pixel data in the external memories.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An apparatus for accessing image data in external memories, comprising:
a plurality of external memories in which a plurality of parallel pixel data are separately stored at assigned addresses, the plurality of parallel pixel data being adjacent to each other in a prescribed pixel block area in a prescribed block unit of the image data;
a determination circuit for outputting, based on a coordinate of at least one pixel data out of the plurality of parallel pixel data, a memory selection signal for selecting an access route to one of the plurality of external memories corresponding to the one pixel data, the coordinate obtained by raster scanning; and
a memory selector for, when receiving the memory selection signal, selecting access routes to the plurality of external memories and accessing the plurality of parallel pixel data in a same cycle.

2. The apparatus according to claim 1, wherein the memory selector selects the access routes to the plurality of external memories corresponding to the plurality of parallel pixel data, based on parity of lowest bits of a horizontal coordinate and a vertical coordinate of the one pixel data out of the plurality of parallel pixel data.

3. The apparatus according to claim 2, wherein the parity is obtained by an Exclusive-OR operation of the lowest bits.

4. The apparatus according to claim 1, wherein in order to perform address assignment, the prescribed block unit is divided into two in a checker pattern, half pixel data is assigned to a first external memory and the other half pixel data is assigned to a second external memory.

5. The apparatus according to claim 1, wherein the determination circuit has an Exclusive-OR circuit.

6. A method for accessing image data in external memories, comprising the steps of:
separately storing a plurality of parallel pixel data at assigned addresses in a plurality of external memories, the plurality of parallel pixel data being adjacent to each other in a prescribed pixel block area in a prescribed block unit of the image data;
obtaining coordinates of the plurality of parallel pixel data by raster scanning;
selecting access routes to the plurality of external memories corresponding to the plurality of parallel pixel data based on an obtained coordinate of at least one pixel data out of the plurality of parallel pixel data; and
accessing the plurality of parallel pixel data in the plurality of external memories in a same cycle.

7. The method according to claim 6, wherein the prescribed pixel block area is rectangular.

8. The method according to claim 6, wherein the access routes to the plurality of external memories corresponding to the plurality of parallel pixel data are selected based on parity of lowest bits of a horizontal coordinate and a vertical coordinate of the one pixel data out of the plurality of parallel pixel data.

9. The method according to claim 8, wherein the parity is obtained by an Exclusive-OR operation of the lowest bits.

10. The method according to claim 6, wherein, in the storing step, the prescribed block unit is divided into two in a checker pattern, and half pixel data is assigned to a first external memory and the other half pixel data is assigned to a second external memory.
